(19) United States
(12) Patent Application Publication
(10) Pub. No.: US 2006/0052012 A1
(43) Pub. Date: Mar. 9, 2006

(54) Protecting device for connectors of computer

(75) Inventors: Yun-Lung Chen, Tu-Cheng (TW); Shao-Bin Zhang, Shenzhen (CN); Jun Tang, Shenzhen (CN); Zhou Xu, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/191,387

(22) Filed: Jul. 28, 2005

(30) Foreign Application Priority Data
Sep. 6, 2004 (CN) 200420083976.1

(51) Int. Cl. H01R 9/22

(52) U.S. Cl. 439/719

(57) ABSTRACT

A protecting device for enclosing cable connectors of a computer comprises a rear panel (10) of a computer chassis, a first member (20) and a second member (30). The rear panel has a plurality of I/O ports (102) for the cable connectors inserting thereinto. The first member attached to the rear panel has at least one first cutout (243, 245). The second member couples to the first member for enclosing the cable connectors, and has at least one second cutout (343, 345) matching the first cutout to provide passages for cables of the cable connectors. The cables are distributed in the passages. The cable connectors are prevented being removed from the first and second members.

### BACKGROUND OF THE INVENTION

1. Field of the Invention

The present invention relates to protecting devices, and more particularly to a protecting device for cable connectors which are secured to a rear panel of a computer chassis.

2. General Background

Many peripheral equipments, such as mouse, keyboard, USB and moveable hard disk drive, are coupled to a computer with cable connectors through I/O ports. Usually, the cable connectors are very easily removed from the computer.

A cable connector is plugged into a socket on a chassis of an electronic device. A bracket is provided for receiving and engaging the connector therebetween. The bracket has a first generally U-shaped member and a second generally U-shaped member disposed in facing relation. A first fastener connects the first member to the second member so that the connector is captured between the first and second members. A second fastener secures at least one of the first and second U-shaped members to the chassis of the electrical device proximate the socket. The cable connector is thus mechanically secured to the chassis of the electrical device. However, there are not protecting devices disclosed for preventing the bracket from exteriorly removing.

What is needed, therefore, is a protecting device which protects cable connectors of the peripheral equipments from unwanted removal.

### SUMMARY

A protecting device for shielding cable connectors of a computer comprises a rear panel of a computer chassis, a first member and a second member. The rear panel has a plurality of I/O ports for the cable connectors inserting thereinto. The first member attached to the rear panel has at least one first cutout. The second member couples to the first member for enclosing the cable connectors, and has at least one second cutout matching the first cutout to provide passages for cables of the cable connectors. The cables are distributed in the passages. The cable connectors are prevented being removed from the first and second members.

Advantages and novel features of the present invention will be drawn from the following detailed description of preferred embodiment with attached drawings, in which:

### BRIEF DESCRIPTION OF THE DRAWINGS

FIG. 1 is an exploded, isometric view of a protecting device of a preferred embodiment of the present invention, the protecting device including a first member, a second member and a rear panel;

FIG. 2 is another isometric view of the first member and the second member;

FIG. 3 is similar to FIG. 1, but showing the first member secured to the rear panel;

FIG. 4 is an assemble view of FIG. 1; and

FIG. 5 is another isometric view of FIG. 4.

### DETAIL DESCRIPTION OF PREFERRED EMBODIMENT

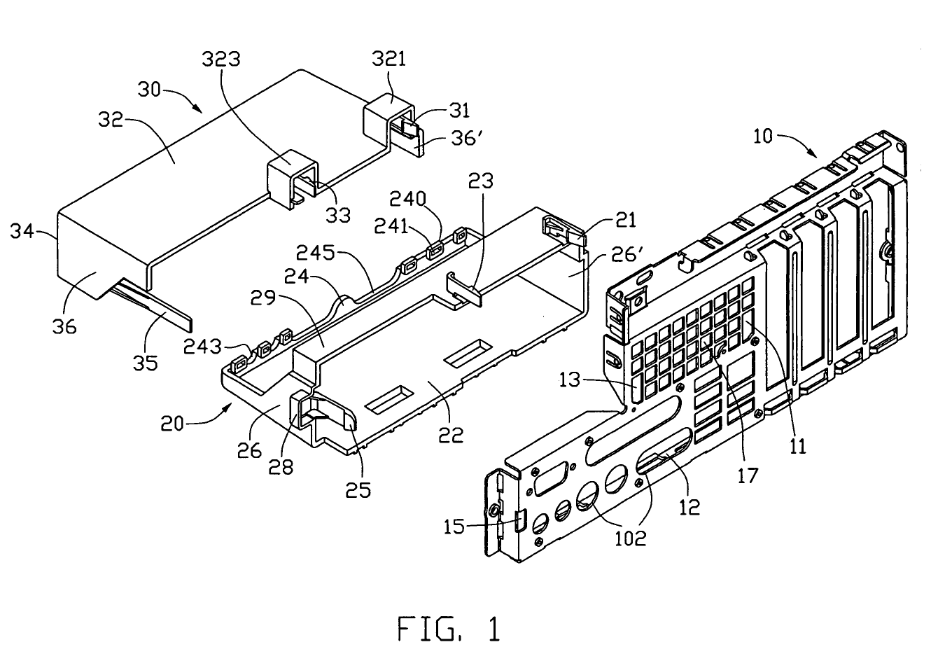

Referring to FIG. 1, a protecting device for cable connectors of an electronic device like a computer in accordance with a preferred embodiment of the present invention includes a rear panel 10 of a computer chassis and a protecting cage including a first member 20 and a second member 30.

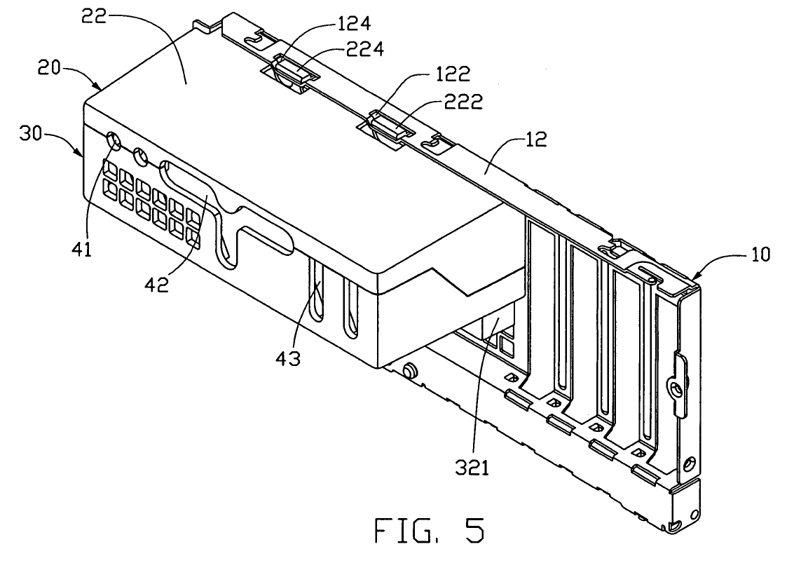

A plurality of I/O ports 102 is defined in the rear panel 10. A mounting hole 15 is defined at an end of the rear panel 10. A plurality of ventilation holes 17 is defined above the I/O ports 102. Two securing slots 11, 13 are defined at two sides of the ventilation holes 17. A bent flange 12 extends from a bottom edge of the rear panel 10. Two latching opening 122, 124 are defined in the bent flange 12, as shown in FIG. 5.

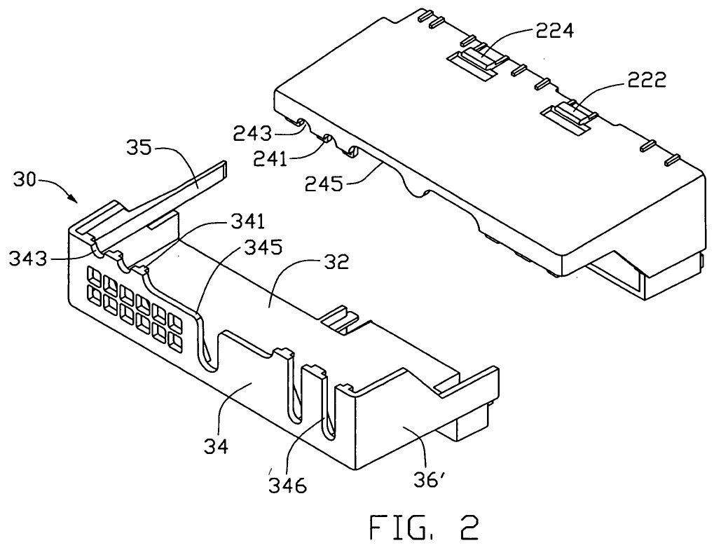

Referring to FIGS. 1 and 2, the first member 20 includes a bottom wall 22 and a pair of side walls 26, 26′ extending upwardly and perpendicularly from opposite edges of the bottom wall 22. A pair of retaining hooks 222, 224 protrudes from the bottom wall 22 for engaging in the latching opening 122, 124, as shown in FIG. 5. A mounting hook 25 extends from the side wall 26 corresponding to the mounting hole 15 of the rear panel 10. Atop plate 29 bestrides the side walls 26, 26′. A pair of locking hooks 21, 23 is formed on the top plate 29 corresponding to the securing slots 11, 13 respectively. A flange 24 protrudes perpendicularly from the bottom wall 22 between the side walls 26, 26′. A plurality of indented positioning blocks 240, each having a positioning hole 241, is formed at a upper edge of the flange 24. A plurality of hemicycle-shaped cutouts 243 and elongated cutouts 245 are defined in the flange 24 between the adjacent positioning blocks 240.

The second member 30 includes a top wall 32 and a pair of side wall 36, 36′ extending downwardly and perpendicularly from opposite edges of the top wall 32. A pair of shielding caps 321, 323 protrudes from the top wall 32. A pair of locking hooks 31, 33 extends forward from the shielding caps 321, 323 respectively, corresponding to the securing slots 11, 13 of the rear panel 10. An elongated lever 35 extends from an inner surface of the side wall 36 for squeezing the mounting hook 25 of the first member 20. A flange 34 protrudes perpendicularly from an edge of the top wall 32 between the side walls 36, 36′. A plurality of securing tabs 341 protrudes from the flange 34, corresponding to the positioning holes 241 of the first member 20. A plurality of hemicycle-shaped cutouts 343, a T-shaped cutout 345 and a plurality of elongated cutouts 346 are defined in the flange 34.

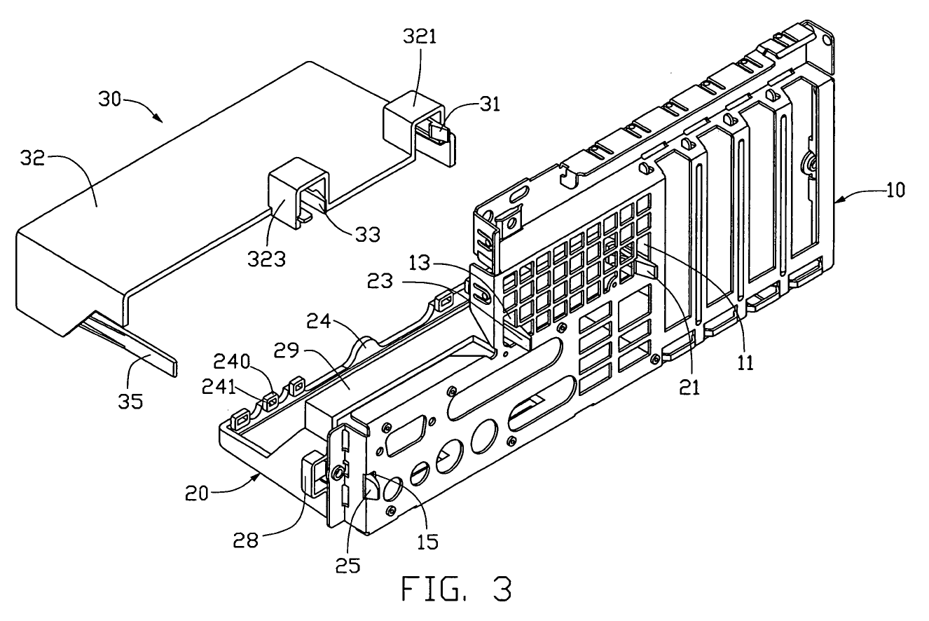

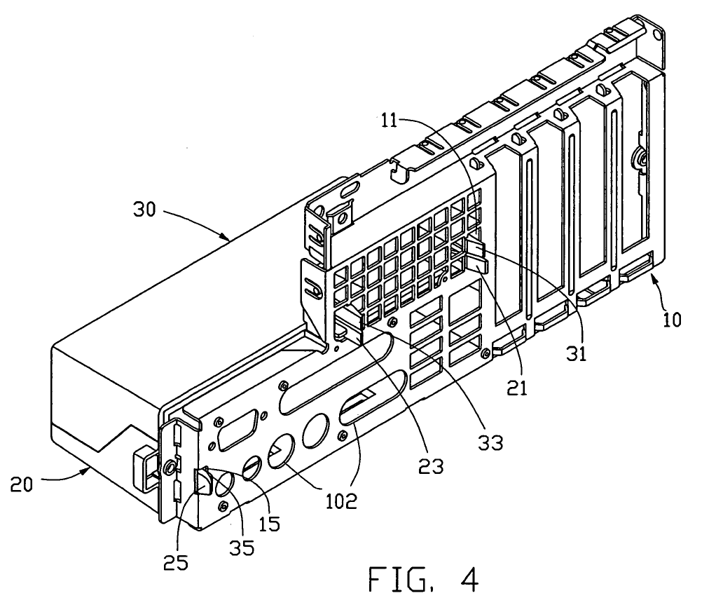

Referring also to FIGS. 3 to 5, the retaining hooks 222, 224 are received into the latching opening 122, 124. Then, the mounting hook 25 and the locking hooks 21, 23 insert and engage into the mounting hole 15 and bottom portions of the securing slots 11, 13 respectively, as shown in FIG. 3. The first member 20 is thus mounted on the rear panel 10.

The second member 30 is placed on the first member 20 with the top plate 29 abutting against the top wall 32. The second member 30 is then pushed to slide along the first member 20 towards the rear panel 10. The securing tabs 341 of the second member 30 are inserted into the positioning holes 241 of the positioning block 240 of the first member 20. The elongated lever 35 is inserted into the mounting hole 15, so that the mounting hook 25 is squeezed by the elongated lever 35 and tightly secured in the mounting hole 15 of the rear panel 10. At the same time, the locking hooks 31, 33 of the second member 30 insert and engage into a top portion of the securing slots 11, 13 respectively. The second member 30 is thus mounted to the rear panel 10. The I/O ports 102 of the rear panel 10 are covered by the first member 20 and the second member 30. The flange 24 of the first member 20 matches the flange 34 of the second member 30. As shown in FIG. 5, the hemicycle-shaped cutouts 243 of the first member 20 join with the hemicycle-shaped cutouts 343 of the second member 30 to form a plurality of round through slot 41. The elongated cutout 245 joins with the T-shaped cutout 345 to form a T-shaped through slot 42. The cutouts 346 of the second member 30 are blocked by the flange 24 of the first member 20, thereby forming a plurality of elongated through slots 43.

In disassembly, the locking hooks 31, 33 of the second member 30 is deformed to disengage from the securing slots 11, 13 of the rear panel with hands inside the chassis. The second member 30 is thus pushed to slide out from the first member 20.

In use, the first member 20 is first mounted to the rear panel 10 of the computer chassis. A plurality of cable connectors of the peripheral equipments is coupled to the I/O ports 102 of the rear panel 10. The cables of the peripheral equipments can be distributed in the cutouts 243, 245 of the first member 30 respectively. The second member 30 is finally mounted to the rear panel 10 for matching the first member 20. The cable connectors are stopped with the through slots 41, 42, 43 of protecting cage, so that the cable connectors cannot be removed outside of the protecting cage.

It is to be understood, however, that even though numerous characteristics and advantages have been set forth in the foregoing description of preferred embodiments, together with details of the structure and function, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. A protecting device for enclosing cable connectors of a computer, comprising:
a rear panel of a computer chassis having a plurality of I/O ports for the cable connectors inserting thereinto;
a first member attached to the rear panel, the first member having at least one first cutout; and
a second member coupling to the first member for enclosing the cable connectors, the second member having at least one second cutout matching the first cutout to provide passages for cables of the cable connectors; whereby the cables are distributed in the passages, the cable connectors are prevented being removed from the first and second members.

2. The protecting device as described in claim 1, wherein the rear panel comprises a bent flange having a pair of latching openings defined therein, and a pair of retaining hooks protrudes from the first member to engage in the latching opening.

3. The protecting device as described in claim 1, wherein a top plate is formed at one of the first and second members for coupling the first member to the second member.

4. The protecting device as described in claim 3, wherein a plurality of hooks is formed at the top plate for engaging with the rear panel.

5. The protecting device as described in claim 1, wherein a plurality of locking hooks protrudes from the second member for engaging in securing slots defined in the rear panel respectively.

6. The protecting device as described in claim 5, wherein a plurality of caps is formed at the second member for covering the locking hooks respectively.

7. The protecting device as described in claim 1, wherein a plurality of positioning blocks extends from the first member for positioning the second member.

8. The protecting device as described in claim 7, wherein a plurality of securing tabs protrudes from the second member for engaging in positioning holes defined in the corresponding positioning blocks.

9. The protecting device as described in claim 1, wherein a mounting hook protrudes from the first member for engaging in a mounting hole defined in the rear panel.

10. The protecting device as described in claim 8, wherein a lever protrudes from the second member for inserting into the mounting hole to have the mounting hook tightly secured in the mounting hole.

11. A protecting device for enclosing cable connectors of a computer, comprising:
a computer chassis having a rear panel with a plurality of I/O ports for the cable connectors inserting thereinto, a mounting hole being defined in the rear panel;
a first member attached to the rear panel, a mounting hook protruding from the first member corresponding to the mounting hole; and
a second member matching the first member, a lever protruding from the second member for squeezing the mounting hook to tightly engage in the mounting hole.

12. The protecting device as described in claim 11, wherein a bent flange extends from the rear panel with a pair of latching opening defined therein, and a pair of retaining hooks protrudes from the first member to engage in the latching opening.

13. The protecting device as described in claim 11, wherein a plurality of cutouts is defined in the first and second members to provide passages for cables of the cable connectors.

14. The protecting device as described in claim 11, wherein a plurality of locking hooks protrudes from the second member for engaging in corresponding securing slots defined in the rear panel respectively.

15. The protecting device as described in claim 14, wherein a plurality of caps is formed at the second member for covering the locking hooks respectively.

16. The protecting device as described in claim 11, wherein a top plate is formed at one of the first and second members for coupling the first member to the second member.

17. The protecting device as described in claim 16, wherein a plurality of hooks is formed at the top plate for engaging with the rear panel.

18. The protecting device as described in claim 11, wherein a plurality of positioning blocks is formed at the first member for positioning the second member.

19. The protecting device as described in claim 17, wherein a plurality of securing tabs protrudes from the second member for engaging in positioning holes defined in corresponding positioning blocks.

20. An electronic device comprising:
a chassis enclosing said electronic device therein, and defining a rear panel provided for further connection to said electronic device and exposable to an outside of said chassis;
a plurality of cable connectors capable of being engagably attached to said rear panel and extendable in said outside of said chassis so as to establish electrical connection with said electronic device; and
a protecting device attachable to said chassis around said rear panel to enclose outside-extension of said plurality of cable connectors commonly so as to protect stability of said electrical connection of said plurality of cable connectors with said electronic device.
